(19) United States
(12) Patent Application Publication
(10) Pub. No.: US 2016/0007289 A1
(43) Pub. Date: Jan. 7, 2016

(54) METHOD AND APPARATUS FOR LOW ENERGY FILTERING

(71) Applicants: Raz Weizman, Beer Sheva (IL); Eddy Kvetny, Rishon-Lezion (IL)

(72) Inventors: Raz Weizman, Beer Sheva (IL); Eddy Kvetny, Rishon-Lezion (IL)

(21) Appl. No.: 14/325,019

(22) Filed: Jul. 7, 2014

(51) Int. Cl. H04W 52/02; H04W 76/02; H04W 4/00

(52) U.S. Cl. CPC H04W 52/0229; H04W 4/008; H04W 76/02

(57) ABSTRACT

The disclosure relates to a method, apparatus and system to filter undesired or redundant messages to thereby conserve energy in wireless devices. In one embodiment, energy is conserved through a successive series of data filters which identify the incoming signals (e.g, advertisement) and determine whether to ignore or to direct the advertisement packet to a higher level data filtering system. The disclosed embodiments conserve energy by maintaining complex processors in sleep mode until the need arises. In another embodiment, external source provide information to the filtering system. In still another embodiment, information from different sources are fused together to provide input to the filtering criteria.

### BACKGROUND

1. Field

The disclosure relates to a method and apparatus to improve filtering in wireless communication. Specifically, the disclosure relates to a method, apparatus and system to filter undesired or redundant messages to thereby conserve energy in wireless devices.

2. Description of Related Art

Wireless communication devices continually exchange solicited and unsolicited messages with other devices within their immediate reach. Bluetooth low energy (BLE) is an exemplary system designed for low energy communication between proximally located devices. BLE provides wireless network technology aimed at novel applications in the healthcare, fitness, security and home entertainment industries. Compared to the conventional Bluetooth (BT) technology, BLE provides considerably reduced power consumption and lower cost while maintaining a similar communication range.

BLE technology provides connectivity between BT mobile devices and a variety of Bluetooth systems, including, cars, exercise devices, computers, tablets and the like. The BLE technology supports a relatively low power consumption of the BT mobile devices. For example, a BT mobile device may be a small sensor, a watch, or a Smartphone having a battery with limited power supply and the BLE technology may enable the BT mobile device to communicate with the variety of systems using a relatively low power consumption.

According to the BLE technology protocol, a first BT device (the BLE central device) and a second BT device (BLE peripheral device) may establish a connection therebetween to enable data exchange. BLE communication begins when one BLE device advertises its presence. The advertising event occurs during regular intervals and over several BLE channels. The corresponding device scans the same BLE channels during the same interval. If the scanning device receives the advertisement on the same channel as advertised, the two BLE devices can synchronize and connect. Once connected, the BLE devices may interact with each other continuously or periodically.

Exchanging data between the BLE central device and the BLE peripheral device at a relatively high rate may increase power consumption of each device and will rapidly deplete battery life.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 schematically illustrates a network for implementing an embodiment of the disclosure;

FIG. 2 schematically illustrates a multilevel data packet filtering architecture according to one embodiment of the disclosure;

FIG. 3 schematically illustrates a flow diagram for implementing one embodiment of the disclosure;

FIG. 4 illustrates an exemplary data packet filtering device according to one embodiment of the disclosure; and

FIG. 5 is an exemplary system for implementing an embodiment of the disclosure.

### DETAILED DESCRIPTION

Certain embodiments may be used in conjunction with various devices and systems, for example, a Personal Computer (PC), a desktop computer, a sensor device, a BT device, a BLE device, an Ultrabook™, a mobile computer, a laptop computer, a notebook computer, a tablet computer, a server computer, a handheld computer, a handheld device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like. Some embodiments may be used in conjunction with devices and/or networks operating in accordance with existing Bluetooth standards (“the BT standards”) as will be discussed further below, e.g., including BT specification V 1.0, Dec. 1, 1991, BT specification V 4.0, Jun. 30, 2010, and/or future versions and/or derivatives thereof.

Some embodiments may be used in conjunction with devices and/or networks operating in accordance with existing Institute of Electrical and Electronics Engineers (IEEE) standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE 802.11 task group ac (TGac) (“IEEE 802.11-09/0308r12—TGac Channel Model Addendum Document”); IEEE 802.11 task group ad (TGad) (IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec. 2012)) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing WirelessHD™ specifications and/or future versions and/or derivatives thereof, units and/or devices which are part of the above networks, and the like.

Some embodiments may be used in conjunction with one way and/or two-way radio communication systems, a BT device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMI) transceiver or device, a Single input Multiple Output (SIMO) transceiver or device, a Multiple input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a “piconet”, a WPAN, a WVAN and the like.

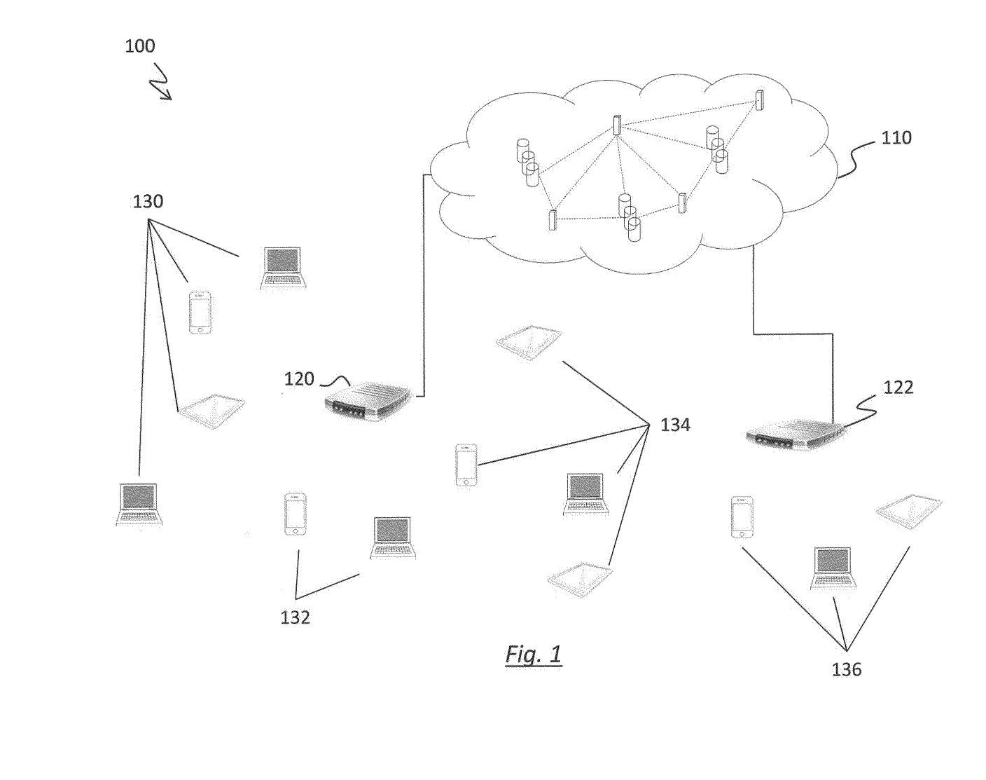

FIG. 1 schematically illustrates an efficient network for implementing an embodiment of the disclosure. Specifically, FIG. 1 shows high efficiency network environment 100 having network 110 communicating with access points (APs) 120, 122. While FIG. 1 shows APs 120 and 122 as part of network 110, the disclosed principles are not limited thereto and are equally applicable to environments where the AP is outside the network. Exemplary mobile stations (STAs) include smartphones, laptops and tablets or any other wireless device. STAs 130, 132, 134 and 136 may communicate with each other as well as with APs 120, 122. Each of APs 120, 122 may define a different WLAN and may comprise a modem, a router or any other circuitry having a processor circuit in communication with a memory circuit adapted to compete for medium and deliver wireless access. APs 120 and 122 may compete with each other and with other devices for the medium. APs 120, 122 as well as STAs 130, 132, 134 and 136 may continually transmit unsolicited data packets to other devices. One or more of the STAs 130, 132, 134 and 136 may comprise a BLE device. BLE devices regularly transmit BLE broadcast signals. The signals contain BLE advertisement messages. BLE advertisement messages contain data. Other BLE devices continually scan for advertisement messages. The BLE advertisement messages enable interaction between BLE devices.

The BLE protocol framework suggests 2 kind of interactions between BLE devices: connectionless and connection-oriented messaging. The connectionless interaction is based on broadcasting information by a device assuming the Peripheral role and discovering this information via scanning by other device assuming the Central role. The connectionless interaction is suitable for discovering other devices in the vicinity of the broadcasting device, and if needed, triggering a connection between the devices. In the connection-oriented interaction devices are able to exchange data at higher speed, better throughput and in more power-efficient manner.

Conventional discovery of any new device is reported to the host BT/BLE stack which can result in awakening of the host/AP. To avoid numerous discovery of the same device in the vicinity the duplicate filtering is conventionally supported by BLE cores. To cut down on repetitive reporting, every device discovered in the vicinity is reported to the host/AP only once. While this protocol is suitable for some applications it is not good for usages based on connectionless interactions with a discovered devices.

One example is proximity tracking based on getting multiple advertisement messages along with received signal strength indicator (RSSI) from a non-connected discovered device (e.g., Apple's iBeacon) and usages when a changing content is broadcast by an advertising BLE device. These usages will not be available if the duplication filtering is performed by the BLE Core. On the other hand, disabling duplication filtering results in waking a host/AP upon getting messages from a discovered device in the vicinity. Redundant reporting has a negative impact on power consumption. Thus, there is a clear tradeoff between power efficiency and usability of connectionless BLE scenarios.

In one embodiment, the disclosure provides a multi-level filtering framework that can apply in intelligent logic to the process of filtering broadcast BLE advertisement signals (interchangeably, advertisement messages) from discovered devices. The advertisement signal may comprise data packet or a null packet. Filtering may include evaluating each advertisement signal for content and/or attribute to determine whether to awake the Host or the higher level processor(s). The logic framework may be distributed between different layers and/or nodes to enhance filtering output and to thereby reduce the number of erroneous or irrelevant messages. Filtering these advertisement signal according to appropriate evaluation criteria reduces the host's activity time (awake time) and reduces battery consumption.

The multilevel filtering system may include several filtering layers. Each filtering layer may be implemented at an independent processor or at a logic layer. Each logic layer may be configured to evaluate advertisement signals according to a predefined criteria. While the disclosed exemplary embodiments show three filtering (or logic) layers, the disclosure is not limited thereto and may include more or less filtering layers. In an exemplary embodiment, the logic layers are implemented at a single die, at a processor or at a system-on-chip (SOC). The processing unit filtering the advertisement messages may communicate with a memory system, radio transceiver(s) and one or more controllers. Each subsequent filtering logic may become progressively sophisticated over the previous layer to perform increasingly complex filtering operation.

In an exemplary embodiment, a multilevel filtering logic comprises three layers. The first logic layer may be implemented at a BLE Core; the second logic layer may be implemented at an Offload Engine and the third logic layer may be implemented at the Host. The BLE core may apply a relatively simple matching logic to compare data received in the incoming data packets with pre-configured data patterns. In some embodiments of the disclosure, the incoming data defines BLE broadcast or advertisement signals having device service identifier, vendor-specific data, etc. which can be compared with preconfigured data patterns.

The Offload Engine may define a more complex filtering logic. The Offload Engine (or the second logic) may apply information from additional sources of contextual information such as connectivity cores or various sensors for further filtering. The BLE core filtering and the Offload Engine filtering may be implemented in one or separate circuitries. Each circuitry may include one or more processors (actual or virtual) in communication with one or more memory modules.

The Host filtering may be performed by the host-based application/stack after the host is awakened. The Host may be awakened only if the advertisement signals or data packets survive the BLE core (or first logic) and the Offload Engine (or second logic). In one embodiment of the disclosure, the lower logics evaluate and filter a large number of advertisement messages in order to minimizing the number of events delivered to the host environment. As the event delivered to the host in low-power state results in waking a host, the framework aims at having minimal number of irrelevant, redundant or fake events awaken the host. In one embodiment, host filtering may require access to cloud infrastructure for authorization and/or authentication of discovered devices and services. The cloud infrastructure may provide an input to the third logic criteria. The input may be additional information or it may be selection criteria itself.

In one embodiment, an Offload Engine is configured to fuse different evaluation criteria from different sources to make smart filtering decisions. These sources may include, for example, connectivity cores, actual and virtual sensors and context engines. For example, a discovered service such as a BLE device may be ignored if a platform is moving faster than a pre-defined threshold to avoid a needless awakening of the Host processor. Similarly, a discovered device with certain characteristics can be ignored at a pre-defined time (e.g., night) or at certain locations (e.g., hospital or theater). In another embodiment, an Offload Engine is configured to fuse information received from different sources as input to the evaluation criteria. In this embodiment, the criteria is stored at the second layer logic and the information from different sources helps decide whether to discard the advertisement.

The Offload Engine also minimizes external resources such as memory or CPU processing. For example, the BLE Core may address relatively simple logic of data matching based on pre-configured data patterns. More sophisticated filtering may be directed to the Offload Engine or more advanced filtering levels. In this manner, the BLE receiver may use a connectionless session between BLE devices for specific filtering without duplication filtering at higher levels. The Host CPU may be awakened only to consider a limited number of broadcasted messages. The Host CPU may engage sophisticated filtering capabilities by accessing the cloud infrastructure to verify authorization and authentication of discovered device and services. The cloud infrastructure (e.g., cloud 110, FIG. 1) may include one or more remote servers and databases to store applicable evaluation criteria.

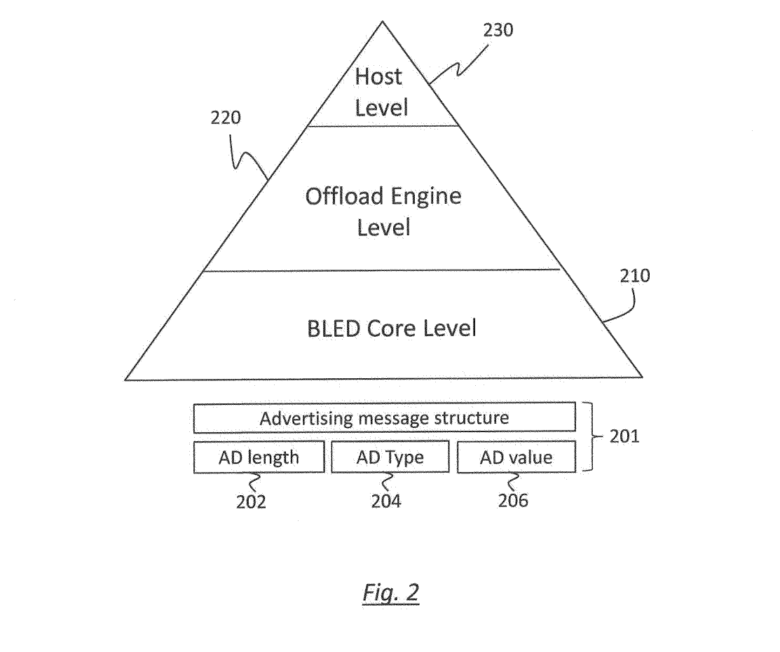

FIG. 2 schematically illustrates a multilevel data packet filtering architecture according to one embodiment of the disclosure. FIG. 2 also illustrates an exemplary data packet as an input to the filtering architecture. The input data packet shown is an exemplary BLE advertising packet 201 having, AD length 202, AD type 204 and AD value 206.

The multilevel data packet filtering system of FIG. 2 allows inputs from a variety of sources to be considered by a smart and complex filtering scheme before awakening the Host AP. The architecture of FIG. 2 includes adding filters in three independent logic layers which creates a hierarchy of filters. The Host may pre-configure the layers so that each filter would comprise a predefined configuration for the received messages. It is noted that while the architecture of FIG. 2 is shown with three levels, the disclosed principles are not limited thereto and different number of filtering levels may be used without departing from the disclosed principles.

In FIG. 2, level 210 defines the BLE Core, Level 210 may be implemented in the BLE Core processor as a coarse filter. Alternatively, the message evaluation of level 210 may be implemented at a first logic level. Since the BLE Core usually has limited CPU and memory bandwidths, the BLE messages may be evaluated as a function of low memory requirement criteria. For example, level 210 may filter data packets 201 based on criteria including: BLE MAC address (not shown), Advertisement (AD) type 204 short AD values 206 and AD length 202.

Level 220 of the hierarchy may be implemented at the Offload Engine or at a second logic. The Offload Engine processor may reside at the same wireless platform and operate independently of the BLE Core processor. The Offload Engine processor may also have access to a memory circuit with filtering instructions. The Offload Engine processor may define a more sophisticated processor as compared with the BLE Core processor and may consume more memory and energy than the latter. Offload Engine 220 may be a multi-functional filter since it may combine more complex filtering and fusion of sources. Fusion of sources may include combining filtering requirements from two or more sources. The fused filtering and evaluation criteria may be readily altered or refined without disturbing the lower or higher filtering levels.

Exemplary filtering requirements for level 220 may include: higher volumes of BLE MAC addresses, AD Types (similar to Core Level), AD values or a portion thereof, bitmaps of advertising messages or a combination of two or more of these requirements.

Fusion filtering of level 220 may use an Offload Engine processor's various inputs to fuse all of filtering criteria into contextual knowledge. Contextual knowledge can identify viability of the message in the context in which it arrives. Contextual knowledge may allow the Offload Engine processor to distinguish between BLE messages which should awaken the Host in one environment versus another.

The fusion filtering input may be generated from other connectivity cores. Other connectivity cores include any connectivity mode other than the primary connectivity mode. For example, if the primary connectivity mode is BLE, other connectivity modes may include Wi-Fi, BT, Global Navigation Satellite System (GNSS), Near Field Communication (NFC) and Wi-Gig.

Other fusion filtering input may include sensor data. The sensor data may include data from actual sensor and virtual sensors. Exemplary sensors include accelerometer, gyro, magnetometer, thermometer barometer and location sensors. The sensors' data may be directed to the Offload Engine to be used as filtering criteria. In one embodiment of the disclosure, sensor data is selected as an additional criteria to the existing filtering requirements. For example, a sensor data may filter out BLE messages that are form a fast-moving source.

In an embodiment of the disclosure, the Offload Engine processor fuses (or combines) all filtering inputs or criteria to make a smart filtering decision. This decision may be a function of much more than the BLE message data itself.

In FIG. 2, level 230 is the third exemplary filtering layer and may be conducted at the Host. Here, the Host processor is awakened to consider any BLE advertisement message that has penetrated levels 210 and 220. After the Host is awakened, it may implement additional filtering of the BLE messages according to more advanced filtering criteria which may require cloud access or other advanced filtering techniques. Alternatively, the data packet may be acted upon or redirected for action.

In one embodiment, the Host configures different filter levels to implement the desired filtering criteria for each level. Energy is conserved because the Host processor awakens only for data packets that have cleared the lower level filters. For example, a stealth device may choose to receive messages only at its home environment. In this case the differentiation between home or outside environment is made by the Offload Engine processor based on GNSS or the Wi-Fi information. In another embodiment, the filtering criteria may be configured so that a device remains active at one environment (e.g., school, home or work) but receives select messages at another environment (e.g., library, theatre or hospital).

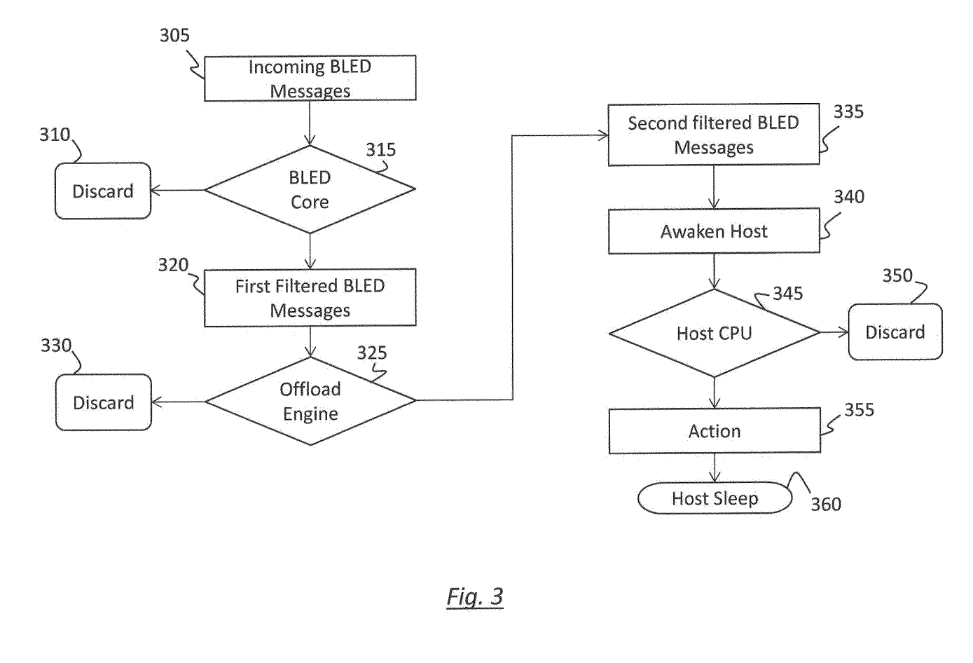

FIG. 3 schematically illustrates a flow diagram for implementing one embodiment of the disclosure. The process begins when incoming BLE advertisement messages 305 are directed to BLE Core for evaluation. The BLE advertisement messages may define one or more data packets. First logic 315 retains criteria for evaluating 315 and discarding 310 incoming messages 305 as a function of this criteria. Evaluation criteria 315 may be programmed to the BLE Core processor or the first logic layer and may include low complexity criteria such as: MAC address, AD type and AD size.

The output of the BLE Core is the first filtered BLE advertisement messages 320. The first filtered BLE messages are received at the Offload Engine or at the second logic. Offload Engine 325 (or second logic) may apply a fusion-type evaluation criteria by combining filtering rules from different sources. For example, Offload Engine 325 may discard first filtered BLE advertisement messages 330 according to the location of the transmitter and/or according to the transmitter's MAC address.

The remaining data packets, if any, form the second filtered BLE advertisement messages 335. The Host CPU is awakened at step 340 to consider the second filtered advertisement messages 335. The Host CPU may include additional filtering criteria. For example, the Host CPU may inquiry a cloud server for additional evaluation criteria. At step 345, Host filters the second filtered advertisement messages and discards certain of the messages 350. Host CPU may optionally take further actions 355 in regards to the remaining advertisement messages (e.g., process information or formulate a response). At step 360, the Host returns to sleep mode to conserve energy.

In the process of FIG. 3, at least one of the Offload Engine or the Host CPU may relate to a secondary communication mode. For example, the Offload Engine or the Host CPU may define Wi-Fi or cellular communication modes. In another exemplary embodiment, the first filtering process may relate to a connectionless communication mode while at least one of the other filtering processes may define a connection-oriented communication mode.

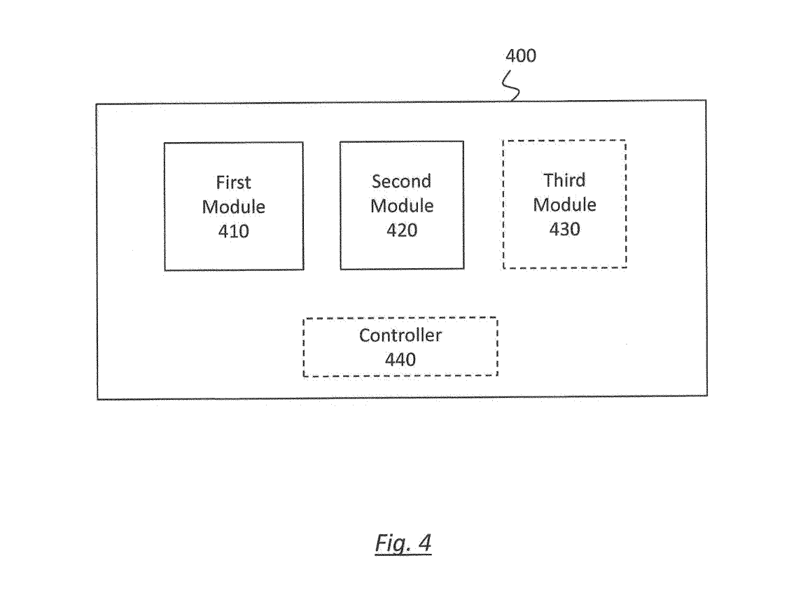

FIG. 4 illustrates an exemplary multilevel BLE data packet filtering apparatus according to one embodiment of the disclosure. Specifically, FIG. 4 shows packet apparatus device 400 having first module 410 and second module 420. The device may optionally include third module 430 and controller 440. Apparatus 400 can be an integral part of a larger system or can be a stand-alone unit. For example, apparatus 400 can define an SOC configured to implement the disclosed methods. Modules 410, 420 and 430 may be hardware, software or a combination of hardware and software. In an exemplary embodiment, each of first module, second module and third module defines an independent logic module. In another embodiment at least one of modules 410, 420 or 430 includes a processor circuit (not shown) in communication with a memory circuit (not shown). Further, apparatus 400 may be part of a larger system having one or more antennas (not shown), a radio (not shown) and a memory system (not shown).

First module 410 of apparatus 400 may comprise a Core processor to evaluate and filter a plurality incoming of BLE advertisement messages as a function of a first criteria to thereby filter redundant or irrelevant BLE messages. In an exemplary embodiment, the first criteria includes BLE packet structure, type or size. The first criteria may also relate to a connectionless communication mode.

Second module 420 may include a second filtering logic. The second module may be implemented at an Offload Engine processor and subsequent to the first module 410. Second module 420 may evaluate and filter BLE messages as a function of a second criteria. In one embodiment, filtering at second module 420 may rely on criteria that is a combination of different source criteria. These sources may include data and environmental sources. The second criteria may include criteria related to other communication modes, such as: Wi-Fi or cellular communication or other connection-oriented communication modes.

Third module 430 may be included optionally. Third module 430 may comprise a Host processor or a third filtering logic to receive output from second module 420. Filtering at third module 430 may be implemented as a function of a criteria retrieved in real-time from an external source.

Controller module 440 may optionally be added to conserve energy by selectively shutting down or activating modules as the need arises. For example, controller module 440 may be configured to awaken third processor module 430 when second processor module 420 has a data packet output. Controller 440 may place one or more of the remaining modules in sleep mode to conserve energy.

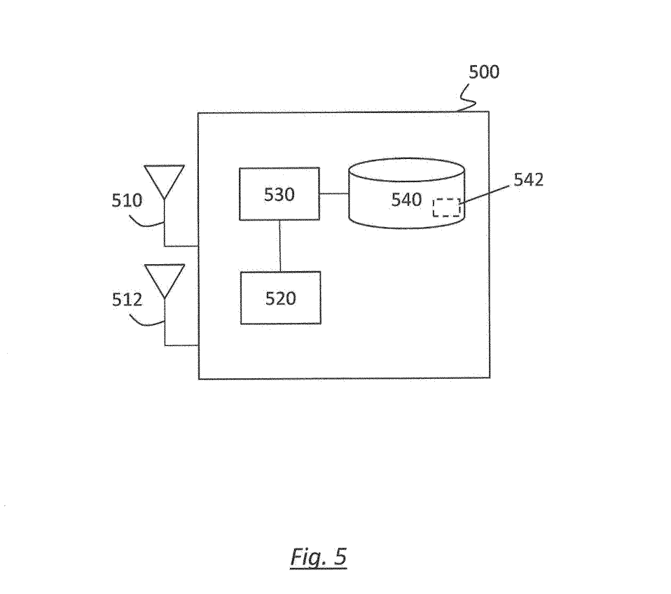

FIG. 5 is an exemplary system for implementing an embodiment of the disclosure. For example, the steps of flow-diagram of FIG. 3 may be implemented in the device of FIG. 5. System 500 of FIG. 5 may define an AP or a smart wireless device capable of multimode communication. System 500 includes antennas 510, 512, one or more radios 520, processor circuit 530 and memory circuit 540. Memory circuit 540 may contain instructions 542 for actuating processor circuitry 530 and radios 520. While system 500 is shown with antenna 510 and 512, the disclosure is not limited to having two antennas. More or fewer antennas may be used to accommodate system 500 to process different communication modes.

The signal(s) received at antenna 510 may be relayed to radio circuitry 520. Radio circuitry 520 may define one radio or multiple radio circuitries adapted to act as front end receivers (RF) for different communication signals. Radio 520 may include transceiver components such as front-end receiver components or a receiver/transmitter. Although not shown, system 500 may be connected to a WLAN or the internet backbone.

Radios 520 can communicate signal information from antennas 510 and 512. The information may include randomly received BLE incoming data packets. Radio(s) 510 may direct the incoming data to processor circuits 530. Processor circuitry 530 may include several processors as discussed in relation to FIG. 4. For example, processor circuitry 530 may include a first logic to filter data packets as a function of the first criteria and to discard unwanted or redundant data packets. Processor circuitry 530 may also include an Offload Engine to identify and discard data packets as a function of a second criteria. The secondary criteria may include a combination of filtering rules from independent sources and sensors as discussed above. Processor circuitry 530 may also include a Host to additionally filter incoming advertisement messages based on the host CPU requirements.

Memory circuit 540 may contain instructions for processor circuitry 530 to implement one or more of the steps of the exemplary processes outlined above. Memory circuit 540 may define a tangible machine-readable non-transitory storage medium that contains instructions, which when executed by one or more processors result in performing operations including: evaluating, at a first logic, information from an advertisement message received from a device as a function of a first criteria to determine whether to establish a wireless communication link with the device. The instructions may further include evaluating, at a second logic coupled to the first logic, information from the first logic and the advertisement message. The second logic may evaluate advertisement messages as a function of a second criteria to determine whether to establish the wireless communication link with the device. The instructions may further include evaluating, at a third logic, coupled to the second logic, information from the second logic and the advertisement message as a function of a third criteria to determine whether to establish the wireless communication link with the device. The second logic evaluation may be subsequent to the first logic evaluation. The third logic evaluation may be subsequent to the second logic evaluation.

The disclosed embodiments provide several advantages over conventional techniques. For example, the disclose embodiments enable a BLE device to filter a high rate of received BLE messages and awaken the host CPU only upon receiving a specific message or message type. The disclosed embodiments also enables fusing multiple filter inputs to generate a smart filtering layer to significantly reduce the rate Host CPU awakening. The disclosed embodiments enable BLE devices to use connectionless sessions therebetween and still maintain a low rate of Host engagement. The disclosed embodiments also enable lowering the system's energy consumption.

The following examples pertain to further embodiments of the disclosure. Example 1 relates to an apparatus comprising one or more processors and circuitry, the circuitry including: a first logic to evaluate information from an advertisement message received from a device as a function of a first criteria to determine whether to establish a wireless communication link with the device; a second logic coupled to the first logic to further evaluate, subsequent to evaluation by the first logic, information from the first logic and the advertisement message, as a function of a second criteria to determine whether to establish the wireless communication link with the device; and a third logic coupled to the second logic to evaluate, subsequent to evaluation by the second logic, information from the second logic and the advertisement message as a function of a third criteria to determine whether to establish the wireless communication link with the device.

Example 2 relates to the apparatus of example 1, wherein the wireless communication link conforms to a Bluetooth® Low Energy (BLE) system standard and wherein the advertisement message is transmitted in a BLE advertisement packet.

Example 3 relates to the apparatus of example 1, further comprising a Core processor, an Offload Engine and a Host for implementing the first, second and third logics, respectively.

Example 4 relates to the apparatus of example 1, wherein the first criteria defines a connectionless communication mode and the second criteria defines a connection-oriented communication mode.

Example 5 relates to the apparatus of example 1, wherein the second logic is configured to receive the second criteria from one or more external sources.

Example 6 relates to the apparatus of example 5, wherein the one or more sources include at least one of modem that conforms with at least one of Wi-Fi, Bluetooth (BT), Global Navigation Satellite Systems (GNSS) or Near Field communication (NFC) standards.

Example 7 relates to the apparatus of example 1, wherein the third logic is configured to receive an input directed to third criteria from a cloud server.

Example 8 relates to the apparatus of example 1, further comprising at least one memory and one or more radios.

Example 9 relates to the apparatus of example 8, further comprising at least one antenna.

Example 10 relates to a tangible machine-readable non-transitory storage medium that contains instructions, which when executed by one or more processors result in performing operations comprising: evaluating at a first logic information from an advertisement message received from a device as a function of a first criteria to determine whether to establish a wireless communication link with the device; evaluating at a second logic coupled to the first logic, subsequent to evaluation by the first logic, information from the first logic and the advertisement message, as a function of a second criteria to determine whether to establish the wireless communication link with the device; and evaluating at a third logic coupled to the second logic, subsequent to evaluation by the second logic, information from the second logic and the advertisement message as a function of a third criteria to determine whether to establish the wireless communication link with the device.

Example 11 relates to the tangible machine-readable non-transitory storage medium of example 10, wherein the second logic receives an input directed to second criteria from one or more external sources.

Example 12 relates to the tangible machine-readable non-transitory storage medium of example 10, wherein the third logic receives an input directed to third criteria from a cloud server.

Example 13 relates to the tangible machine-readable non-transitory storage medium of example 10, wherein the one or more sources include at least one of modem that conforms with at least one of Wi-Fi, Bluetooth (BT), Global Navigation Satellite Systems (GNSS) or Near Field communication (NFC) standards.

Example 14 relates to the tangible machine-readable non-transitory storage medium of example 10, wherein the wireless communication link conforms to a Bluetooth® Low Energy (BLE) system standard and wherein the advertisement message is transmitted in a BLE advertisement packet.

Example 15 relates to a method to filter advertisement messages received from a communication device, the method comprising: evaluating, at a first logic, information from the advertisement messages as a function of a first criteria to determine whether to establish a wireless communication link with the device; evaluating, at a second logic, coupled to the first logic, subsequent to evaluation by the first logic, information from the first logic and the advertisement message, as a function of a second criteria to determine whether to establish the wireless communication link with the device; and evaluating, at a third logic, coupled to the second logic, subsequent to evaluation by the second logic, information from the second logic and the advertisement message as a function of a third criteria to determine whether to establish the wireless communication link with the device.

Example 16 relates to the method of example 15, further comprising receiving an input directed to the second criteria from one or more external sources

Example 17 relates to the method of example 15, further comprising receiving an input directed to the third criteria from a cloud server.

Example 18 relates to the method of example 15, wherein the one or more sources include at least one of modem that conforms with at least one of Wi-Fi, Bluetooth (BT), Global Navigation Satellite Systems (GNSS) or Near Field communication (NFC) standards.

Example 19 relates to the method of example 15, further comprising implementing the first, second and third logics at a Core processor, an Offload Engine and a Host, respectively.

Example 20 relates to the method of example 15, wherein the first criteria further comprises a connectionless communication mode and the second criteria further comprises a connection-oriented communication mode.

While the principles of the disclosure have been illustrated in relation to the exemplary embodiments shown herein, the principles of the disclosure are not limited thereto and include any modification, variation or permutation thereof.

What is claimed is:

1. An apparatus comprising one or more processors and circuitry, the circuitry including:
a first logic to evaluate information from an advertisement message received from a device as a function of a first criteria to determine whether to establish a wireless communication link with the device;
a second logic coupled to the first logic to further evaluate, subsequent to evaluation by the first logic, information from the first logic and the advertisement message, as a function of a second criteria to determine whether to establish the wireless communication link with the device; and
a third logic coupled to the second logic to evaluate, subsequent to evaluation by the second logic, information from the second logic and the advertisement message as a function of a third criteria to determine whether to establish the wireless communication link with the device.

2. The apparatus of claim 1, wherein the wireless communication link conforms to a Bluetooth® Low Energy (BLE) system standard and wherein the advertisement message is transmitted in a BLE advertisement packet.

3. The apparatus of claim 1, further comprising a Core processor, an Offload Engine and a Host for implementing the first, second and third logics, respectively.

4. The apparatus of claim 1, wherein the first criteria defines a connectionless communication mode and the second criteria defines a connection-oriented communication mode.

5. The apparatus of claim 1, wherein the second logic is configured to receive the second criteria from one or more external sources.

6. The apparatus of claim 5, wherein the one or more sources include at least one of modem that conforms with at least one of Wi-Fi Bluetooth (BT), Global Navigation Satellite Systems (GNSS) or Near Field communication (NFC) standards.

7. The apparatus of claim 1, wherein the third logic is configured to receive an input directed to third criteria from a cloud server.

8. The apparatus of claim 1, further comprising at least one memory and one or more radios.

9. The apparatus of claim 8, further comprising at least one antenna.

10. A tangible machine-readable non-transitory storage medium that contains instructions, which when executed by one or more processors result in performing operations comprising:
evaluating at a first logic information from an advertisement message received from a device as a function of a first criteria to determine whether to establish a wireless communication link with the device;
evaluating at a second logic coupled to the first logic, subsequent to evaluation by the first logic, information from the first logic and the advertisement message, as a function of a second criteria to determine whether to establish the wireless communication link with the device; and
evaluating at a third logic coupled to the second logic, subsequent to evaluation by the second logic, information from the second logic and the advertisement message as a function of a third criteria to determine whether to establish the wireless communication link with the device.

11. The tangible machine-readable non-transitory storage medium of claim 10, wherein the second logic receives an input directed to second criteria from one or more external sources.

12. The tangible machine-readable non-transitory storage medium of claim 10, wherein the third logic receives an input directed to third criteria from a cloud server.

13. The tangible machine-readable non-transitory storage medium of claim 10, wherein the one or more sources include at least one of modem that conforms with at least one of Wi-Fi, Bluetooth (BT), Global Navigation Satellite Systems (GNSS) or Near Field communication (NFC) standards.

14. The tangible machine-readable non-transitory storage medium of claim 10, wherein the wireless communication link conforms to a Bluetooth® Low Energy (BLE) system standard and wherein the advertisement message is transmitted in a BLE advertisement packet.

15. A method to filter advertisement messages received from a communication device, the method comprising:
evaluating, at a first logic, information from the advertisement messages as a function of a first criteria to determine whether to establish a wireless communication link with the device;
evaluating, at a second logic, coupled to the first logic, subsequent to evaluation by the first logic, information from the first logic and the advertisement message, as a function of a second criteria to determine whether to establish the wireless communication link with the device; and
evaluating, at a third logic, coupled to the second logic, subsequent to evaluation by the second logic, information from the second logic and the advertisement message as a function of a third criteria to determine whether to establish the wireless communication link with the device.

16. The method of claim 15, further comprising receiving an input directed to the second criteria from one or more external sources

17. The method of claim 15, further comprising receiving an input directed to the third criteria from a cloud server.

18. The method of claim 15, wherein the one or more sources include at least one a modem that conforms with at least one of Wi-Fi, Bluetooth (BT), Global Navigation Satellite Systems (GNSS) or Near Field communication (NFC) standards.

19. The method of claim 15, further comprising implementing the first, second and third logics at a Core processor, an Offload Engine and a Host, respectively.

20. The method of claim 15, wherein the first criteria further comprises a connectionless communication mode and the second criteria further comprises a connection-oriented communication mode.
